(19) United States
(12) Patent Application Publication
(10) Pub. No.: US 2011/0038232 A1
(43) Pub. Date: Feb. 17, 2011

(54) LIGHT EMITTING DIODE BASED CLOCK

(75) Inventors: XIAO-GUANG SU, Shenzhen City (CN); KIM-YEUNG SIP, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 12/566,691

(22) Filed: Sep. 25, 2009

(30) Foreign Application Priority Data
Aug. 14, 2009 (CN) 200910305654.4

(51) Int. Cl. G04C 19/00

(52) U.S. Cl. 368/82

(57) ABSTRACT

A light emitting diode (LED) base clock includes a clock face and twelve groups of LEDs. The twelve groups of LEDs are arranged as an hourly indicator. Each group of LEDs are arranged as a minutely indicator. The clock further comprising a time signal generator configured for generating time signals and selectively drive corresponding LEDs to light using the time signals to display the time and keep time.

### BACKGROUND

1. Technical Field

The present disclosure relates to clocks.

2. Description of Related Art

Generally, clocks can be categorized into two types: analog and digital. Analog clocks display the time through a fixed numbered indicator and a number of moving hands. However, because of the moving parts, most analog clocks are easily worn out and or damaged. Digital clocks display the time by four digits and typically use a seven-segment light liquid crystal display (LCD). However, the clock face of the digital clocks is typically smaller than that of the analog clocks, resulting in unsatisfactory readability of the digital clocks. Also, the readability of the digital clocks is limited by the brightness, the contrast, and the view angle of the LCDs.

Therefore, there is need for improvement in the art.

### BRIEF DESCRIPTION OF THE DRAWINGS

FIG. 1 is a schematic view of a clock, according to an exemplary embodiment.

FIG. 2 is an enlarged view of a portion II of FIG. 1.

FIG. 3 is a schematic view of a clock, according to another exemplary embodiment.

FIG. 4 is an enlarged view of a portion IV of FIG. 3.

FIG. 5 is an enlarged view of a portion V of FIG. 3.

### DETAILED DESCRIPTION

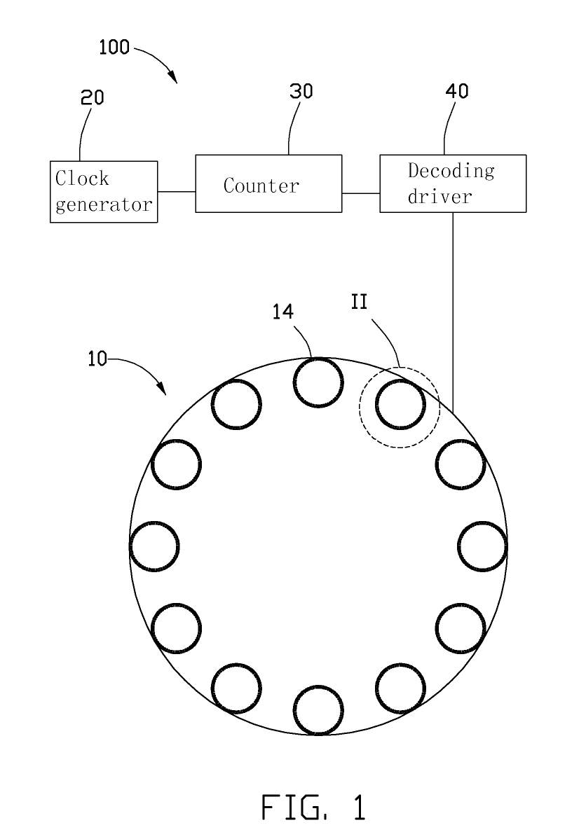

Referring to FIG. 1, a clock 100, according to an exemplary embodiment, includes a clock face 10, a clock signal generator 20, a counter 30, and a decoding driver 40.

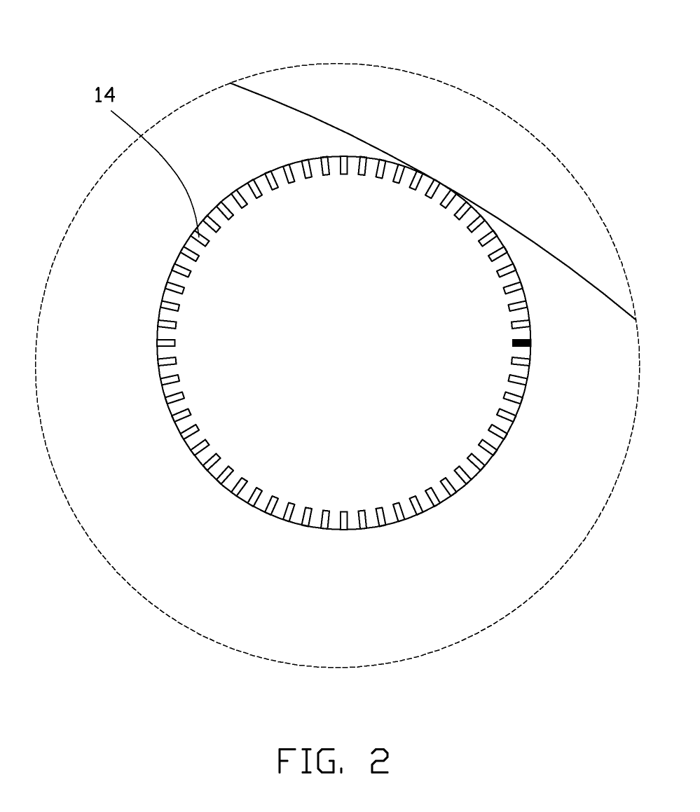

The clock face 10 is circular and includes twelve groups of light emitting diodes (LEDs) 14. The twelve groups of light emitting diodes (LEDs) 14 are arranged as an hourly indicator (not labeled). In this embodiment, the twelve groups of LEDs 14 are arranged around the inner periphery with a uniform distance between each two adjacent groups. Each group of LEDs 14 includes sixty LEDs 14 (see FIG. 2) which are arranged as a minutely indicator (not labeled). For example, LEDs 14 in each group are arranged in a circle with a uniform distance between each two adjacent LEDs 14.

The clock generator 20 is for keeping time and can be a 50 or 60 hertz oscillation of AC power or a crystal oscillator. In this embodiment, the clock generator 20 is a crystal oscillator and configured for generating base clock signals.

The counter 30 is configured for counting the base clock signals and thereby outputs minute signals. For example, if the interval of the base clock signals is 0.02 s. The counter 30 counts 3000 base clock signals in the interval of the minute signals.

The decoding driver 40 is configured for receiving and decoding the minute signals, and driving and maintaining a corresponding LED 14 to light until a succeeding minute signal is received. For example, referring to FIG. 2, if a received minute signal is decoded as the time 1:15. The decoding driver 40 drives and maintains the fifteenth LED 14 of the first minute-cycle to light until a minute signal indicative of the time 1:16 is received.

The clock 100 arranges LEDs 14 as indicators. The LEDs 14 can service for a longer time, as compared with those employed mechanical structure, with satisfactory brightness, contrast, and can be read at all angles. Therefore, the clock 100 can provide satisfactory readability while servicing longer time.

It should be noted that the clock face 10 is not limited to this embodiment. In other alternative embodiments, the clock face 10 can be triangular, rectangular, or any other decorative shapes.

The twelve groups of LEDs 14 can be arranged on any portion of the clock face 10, e.g., center, and the other portion of the clock face 10 can be decorated.

Instead of a circle, for decorative purposes, the twelve groups of LEDs 14 or each group of LEDs 14 can be arranged in other shapes, for example, a rectangle.

Further, if the accuracy of the clock 100 is not of high requirement, less groups of LEDs 14 or less LEDs 14 of each group can be used. For example, in one alternative embodiment, four groups of LEDs 14, each of which has thirty LEDs 14, are employed (not shown) and the accuracy is 6 minutes.

In other alternative embodiments, different groups of LEDs 14 can employ different color LEDs. For example, the 12-hour group of LEDs 14 can use blue LEDs, the 1-hour group of LEDs 14 can use green LEDs, and the 2-hour group of LEDs 14 can use red LEDs. As such, readers can judge the approximate time merely based upon the color of light emitted from the clock 100.

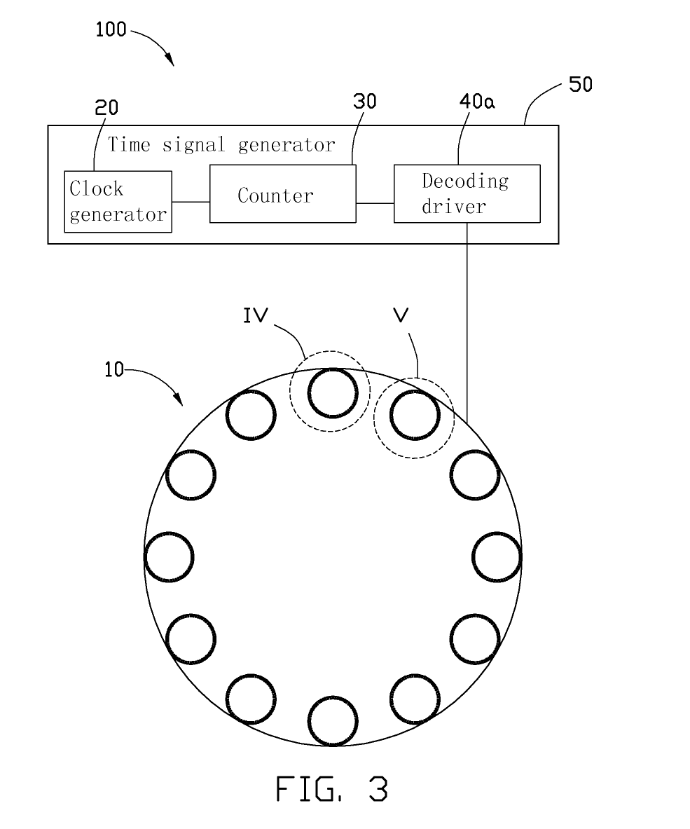

The clock generator 20, the counter 30, and the decoding driver 40 are individual elements in this embodiment. However, referring to FIG. 3, in an alternative embodiment, the clock generator 20, the counter 30, and the decoding driver 40a (see below) can be integrated into a single time signal generator 50.

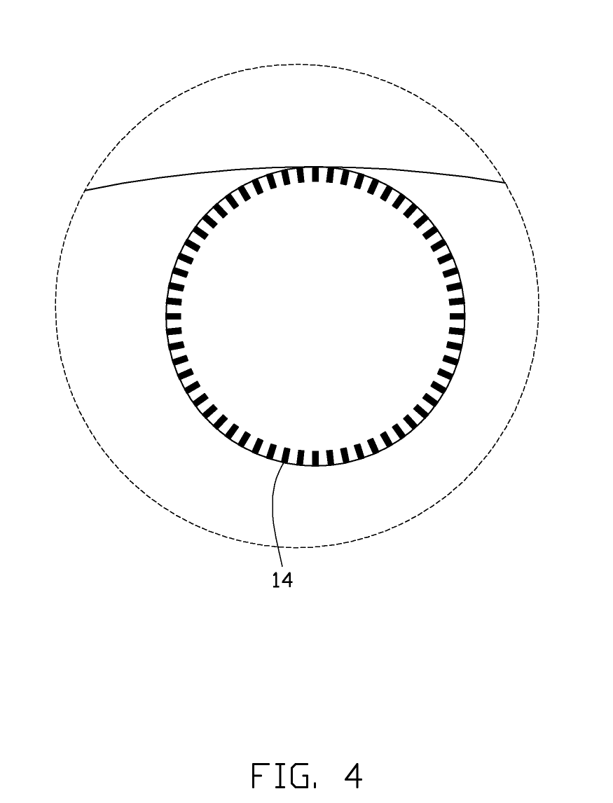

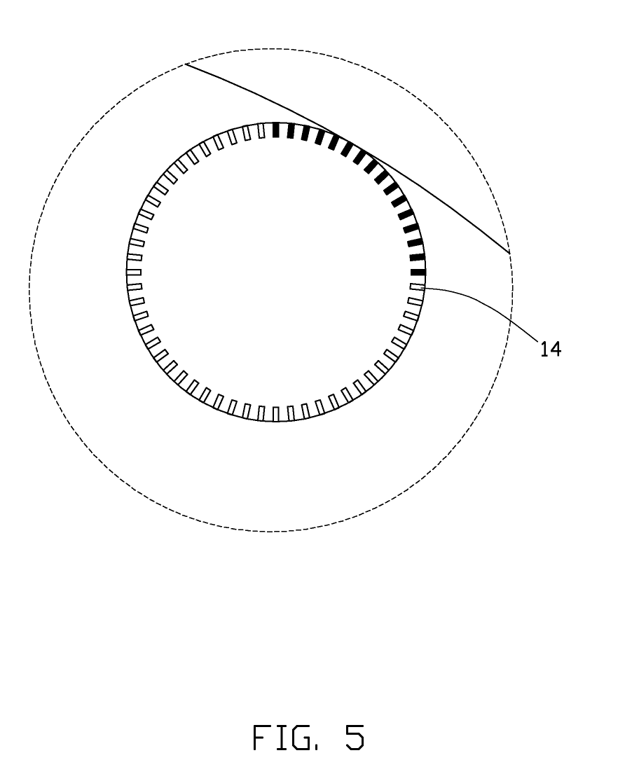

The decoding driver 40 is also not limited to this embodiment too. In an alternative embodiment, a decoding driver 40a is used. The decoding driver 40a is configured for driving all LEDs 14 between the first of the first hour-cycle and one indicative of the time to light. For example, as shown in FIGS. 4-5, all LEDs 14 before the first of the first hour-cycle and the one corresponding to the time 1:15 are all lit.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

1. A clock comprising:
a clock face comprising a plurality of groups of light emitting diodes (LEDs) arranged as an hour indicator, each group as a whole corresponding to a unique hour or unique hours, the LEDs in the group being arranged as a minute indicator, each LED corresponding to a unique minute or unique minutes in the hour or hours corresponding to the group; and
a time signal generator configured for generating a plurality of consecutive time signals and selectively driving the corresponding LEDs to display the time.

2. The clock of claim 1, wherein the clock face has a shape selected from the group consisting of a circle, a triangle, and a rectangle.

3. The clock of claim 1, wherein the clock face is circular, the groups of LEDs are arranged around the inner periphery of the clock face with a uniform distance between each two adjacent groups as the hour indicator.

4. The clock of claim 1, wherein the groups of LEDs are arranged in a rectangle with a uniform pitch as the hour indicator.

5. The clock of claim 1, wherein the number of the groups of LEDs is twelve, each group as a whole corresponding to one unique hour.

6. The clock of claim 1, wherein the number of the groups of LEDs is four, each group as a whole corresponding to three unique hours.

7. The clock of claim 1, wherein each group of LEDs are arranged in a circle with a uniform pitch as the minute indicator.

8. The clock of claim 1, wherein each group of LEDs are arranged in a rectangle with a uniform pitch as the minute indicator.

9. The clock of claim 5, wherein the number of LEDs in each group of LEDs is sixty, each LED of the group corresponding to one unique minute in the hour corresponding to the group.

10. The clock of claim 5, wherein the number of LEDs in each group of LEDs is thirty, each LED of the group corresponding to two unique minutes in the hour corresponding to the group.

11. The clock of claim 1, wherein different groups of LEDs comprise different color LEDs.

12. The clock of claim 1, wherein the time signal generator comprises:
a clock generator generating a plurality of consecutive base clock signals;
a counter configured for counting the base clock signals and generating a plurality of consecutive minute signals indicative the time; and
a decoding driver configured for driving the corresponding LEDs to light based upon the minute signals.

13. The clock of claim 12, wherein the clock generator is selected from the group consisting of an oscillation of AC power or a crystal oscillator.

14. The clock of claim 12, wherein the decoding driver drives an LED corresponding to the time to light and maintain the LED to light until a succeeding minute signal is received.

15. The clock of claim 12, wherein the decoding driver drives all LEDs between the first one and the one corresponding to the time to light.

16. The clock of claim 12, wherein the all the clock generator, the counter, and the decoding driver are integrated into a single chip.

17. The clock of claim 12, wherein the clock generator, the counter, and the decoding driver are individual elements.
